(19) United States
(12) Patent Application Publication
(10) Pub. No.: US 2019/0374312 A1
(43) Pub. Date: Dec. 12, 2019

(54) IMPLANT DEVICE

(71) Applicants: TAIWAN SHAN YIN INTERNATIONAL CO., LTD., Kaohsiung City (TW); BIOMATE MEDICAL DEVICES TECHNOLOGY CO., LTD., Kaohsiung City (TW)

(72) Inventors: KOU-TSAIR SU, KAOHSIUNG CITY (TW); YU-JUNG SU, KAOHSIUNG CITY (TW)

(21) Appl. No.: 16/002,335

(22) Filed: Jun. 7, 2018

(51) Int. Cl. A61C 8/00

(52) U.S. Cl. CPC A61C 8/0037; A61C 2008/0046; A61C 8/0025

(57) ABSTRACT

An implant device includes an implant with a threaded portion and a drilling portion and a positioning hole respectively formed at two ends of the implant. Pores are recessed into a surface portion of the implant. Each pore has a peripheral wall. The peripheral wall and the surface portion meet an end edge. Adjacent end edges and peripheral walls are joined to cause adjacent pores to communicate one after another, thereby forming communicating channels. When the implant is fastened to a target part, cells derived from the target part are quickly attached to the end edges and enter the channels to attain a smooth adhesion and proliferation. The proliferated cells climb between the pores and channels and become linked to hold the implant firmly and enhance the combination between the implant and the target part, thereby shortening the convalescence period of the target part.

### BACKGROUND OF THIS INVENTION

### 1. Field of this Invention

This invention relates to an implant device and relates particularly to an implant which benefits the proliferation of cells and speeds up the process of healing the implanted part.

### 2. Description of the Related Art

An implant device is widely applied. Particularly, it is commonly used in the dental field and orthopedics, and herein the implant device applied to the dental implantology is taken as an example. It is known to fix a metal implant to the alveolar bone in the oral cavity for treating missing or broken teeth. After the implant is implanted into the alveolar bone, bone cells derived from the bone need to combine with the implant to attain an osseointegration effect. Generally, the implant has a porous structure whereby the cells are attached to the porous structure to combine with the implant. However, traditional pores are usually spaced apart at different distances and are different in size and depth. This traditional design takes lots of time to complete the osseointegration because reborn cells of the alveolar bone are too small to climb between the pores and it takes the cells lots of time to grow and increase in size. The bone cells cannot climb between the adjacent pores until they grow up to have a size sufficient to climb between the pores and link. This causes a long period of osseointegration and thus the bone tissue requires a long convalescence period. Therefore, the traditional design needs improvement.

### SUMMARY OF THIS INVENTION

An object of this invention is to provide an implant device which allows cells to be quickly and smoothly attached to the implant and promotes the growth of cells, thereby attaining a stable combination between the implant and the target part and shortening the convalescence period of the tissue of the target part.

An implant device of this invention includes an implant with a threaded portion, and a drilling portion and a positioning hole respectively formed at two ends of the implant. There are pores recessedly formed into a surface portion of the implant, which at least includes a shank surface exposed between spaced-apart adjacent threads of the threaded portion. Each pore has a peripheral wall. The peripheral wall and the surface portion meet at an end edge. Adjacent end edges are joined and thus adjacent peripheral walls are connected. This allows the adjacent pores to communicate one after another and thus defines a channel. The pores are joined and communicated in respective rows, so the implant has a plurality of channels by rows of the communicating pores. Accordingly, when the implant device is fastened to a target part, reborn cells of the target part grip the end edges of the pores easily and enter each channel caused by the joined pores for adhering, growing and proliferating quickly. The proliferated cells further stretch out of the pores and channels to be continuously attached to other pores and channels, and then the cells link together to combine with the implant in a short time. The above action allows the entire implant to be wrapped by the linked cells and held in position. Therefore, the combination between the implant and the target part is promoted to prevent the loosening of the implant and shorten the convalescence period of the tissue of the target part.

Preferably, each end edge has a non-smooth border to benefit the adhesion of cells.

Preferably, in one preferred embodiment, only the shank surface is provided with the pores. In other preferred embodiment, not only the shank surface but also a thread surface of partial or all threads of the threaded portion can be provided with the pores.

Preferably, the threaded portion includes at least two thread sections with respective thread pitches formed between any two adjacent threads of respective thread sections. The thread pitches are different from each other. Further, a second maximum outer diameter of the second end can be larger than a first maximum outer diameter of the first end to facilitate a rapid drilling action.

Preferably, the end edges of the pores are joined in a lateral row to form a laterally-communicating and independent channel. Alternatively, the end edges are axially joined to form a longitudinal and independent channel. Alternatively, the end edges are joined in both directions to allow adjacent channels to communicate with each other, thereby forming a mutual communication between the channels.

### BRIEF DESCRIPTION OF THE DRAWINGS

FIG. 1 is a schematic view showing a first preferred embodiment of this invention;

FIG. 2 is a schematic view showing a second preferred embodiment of this invention;

FIG. 3 is a schematic view showing a third preferred embodiment of this invention;

FIGS. 4A to 4H are schematic views showing alternative embodiments of the communication of the pores, wherein FIGS. 4A and 4B are enlarged view to show the alternative embodiments of the part circled in FIG. 1; FIGS. 4C, 4D and 4G are enlarged view to show the alternative embodiments of the part circled in FIG. 2; FIGS. 4E, 4F and 4H are enlarged view to show the alternative embodiments of the part circled in FIG. 3;

FIGS. 5A to 5C are plan views showing alternative embodiments of the communicating arrangements of the channels caused by rows of communicating pores;

FIG. 6 is a perspective view of FIG. 5A; and

FIGS. 7 to 9 are schematic views showing the implant device of this invention applied to the dental implanting surgery.

### DETAILED DESCRIPTION OF THE PREFERRED EMBODIMENTS

An implant device 3 of this invention can be mainly applied to medical implanting field. It can be fastened to a target part where the proliferation of cells is required in the field of dentistry, orthopedics and the like. For example, it may serve as an artificial implant implanted into an alveolar bone of the oral cavity. It may serve as a fixture like an artificial screw used in the orthopedic surgery. In the preferred embodiments of this invention, it is taken as an example that the target part is the alveolar bone in the oral cavity, and the implant device 3 is a root implant implanted into the alveolar bone.

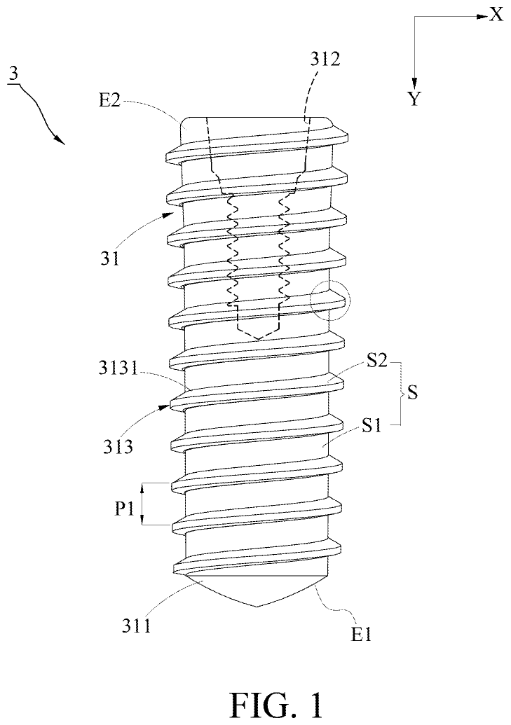

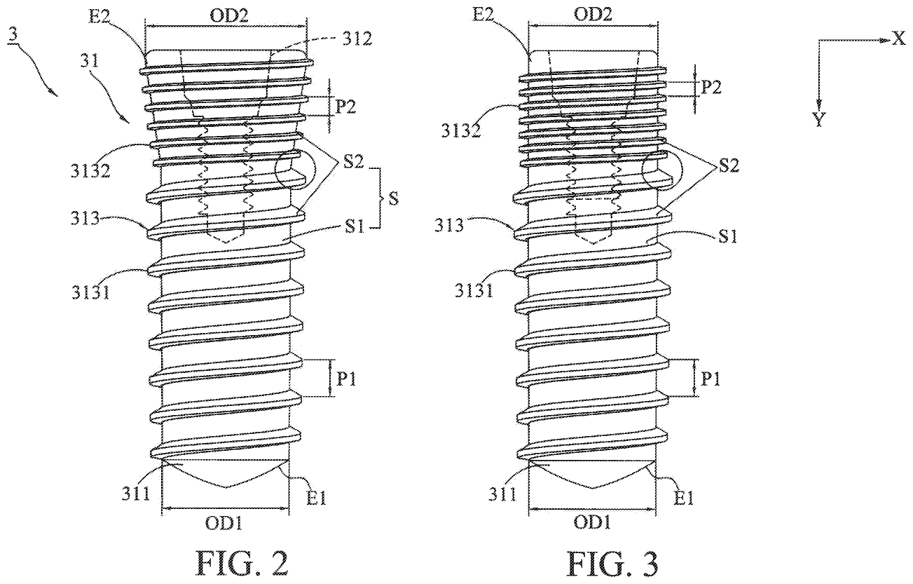

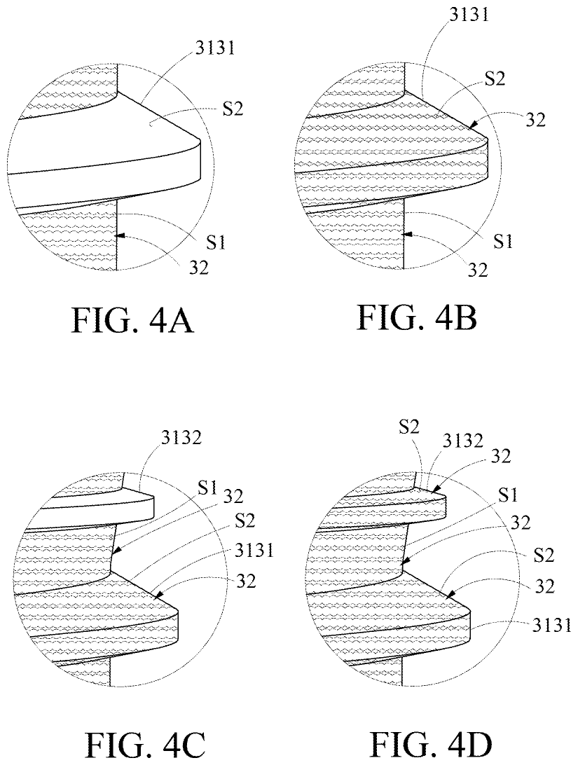

Referring to FIG. 1, an implant device 3 of this invention includes an implant 31, a drilling portion 311 and a positioning hole 312 formed opposite to the drilling portion 311. Specifically, the implant 31 defines a first end E1 and a second end E2 opposite to the first end E1. The drilling portion 311 is disposed at the first end E1. The positioning hole 312 is formed at the second end E2, opposite to the drilling portion 311. The implant 31 further has a threaded portion 313 spirally disposed between the two ends E1, E2. The threaded portion 313 can include a single-convoluted thread section 3131 extending from the first end E1 to the second end E2 and defining a thread pitch P1 between any two adjacent threads of the thread section 3131 (shown in FIG. 1). Alternatively, the threaded portion 313 includes at least two thread sections 3131, 3132 (shown in FIGS. 2-3), and two thread sections are taken as an example in the preferred embodiments. As shown in the figures, a first thread section 3131 spirally extends from the first end E1 of the implant 31, and a second thread section 3132 extends from the first thread section 3131 to the second end E2. A thread pitch P1 is defined between any two adjacent threads of the thread section 3131. Between any two adjacent threads of the second thread section 3132 is defined a thread pitch P2 which can be different from the thread pitch P1, and herein the thread pitch P1 of the first thread section 3131 is preferably larger than the thread pitch P2 of the second thread section 3132. Furthermore, the second end E2 has a second maximum outer diameter OD2 which can be equal to (FIG. 3) or larger than (FIG. 2) a first maximum outer diameter OD1 of the first end E1. When the diameter OD2 is larger than the diameter OD1, the diameter of the part of the implant 31 where the second thread section 3132 is located progressively increases to allow a thread diameter of the second thread section 3132 to gradually increase in a direction opposite to the drilling portion 311 and flare radially outward. This helps a rapid and stable fastening effect.

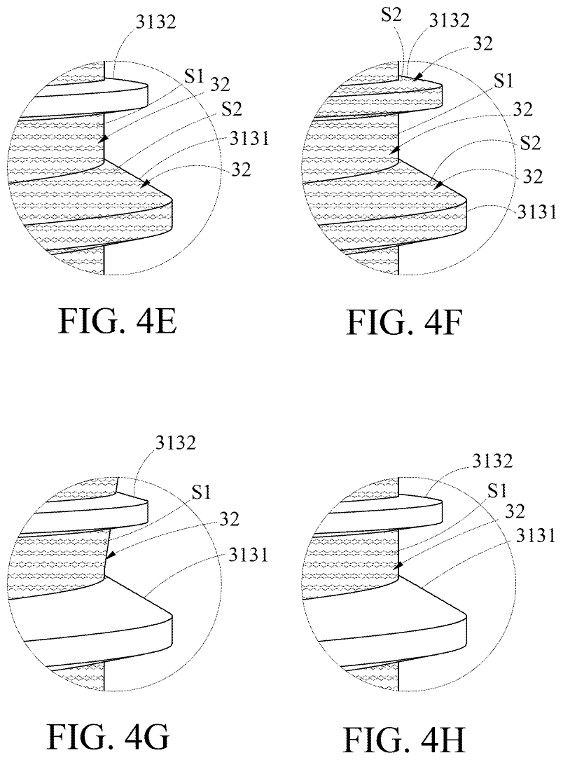

There are pores 32 recessed into a surface portion S of the implant 31. The size and the shape of the pores 32 are not limited. The surface portion S includes any exposed surfaces of the implant 31. For example, the surface portion S can include a shank surface S1. The shank surface 81 is an outer surface extending axially from the first end 81 to the second end E2 and is exposed to an outside. Any two adjacent threads of the threaded portion 313 are axially spaced apart to expose the outer surface. It is also possible that the surface portion S includes the shank surface 81 and a thread surface 82 of all or part of threads of the threaded portion 313. Accordingly, partial or all exposed parts of the implant 31 can be provided with the pores 32. For instance, regarding a single convolution shown in FIG. 1, adjacent threads of the threaded portion 3131 are axially spaced apart to expose the shank surface S1, and pores 32 are formed within the shank surface S1 (shown in FIG. 4A). Alternatively, the shank surface S1 and any thread surface 82 of the threads of the thread section 3131, such as an upper flank face, a lower flank face and both flank faces, are provided with the pores 32, as shown in FIG. 4B.

Regarding the structure with two convolutions shown in FIGS. 2-3, adjacent threads of the threaded portions 3131, 3132 are axially spaced apart to expose the shank surface 81, and pores 32 are formed within the shank surface 81 (shown in FIGS. 4G and 4H). It is also possible that the shank surface 81 and any thread surface 82 of the threads of the thread section 3131 are provided with the pores 32 (shown in FIGS. 4C and 4E). Alternatively, the shank surface 81 and any thread surface 82 of the threads of the thread sections 3131, 3132, such as an upper flank face, a lower flank face and both flank faces, are provided with the pores 32 (shown in FIGS. 4D and 4F).

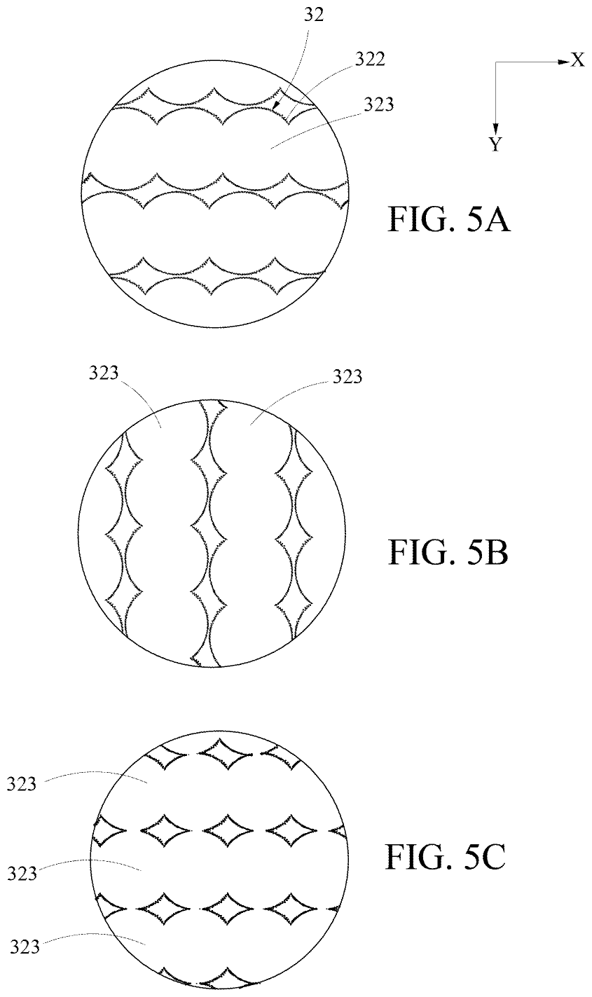

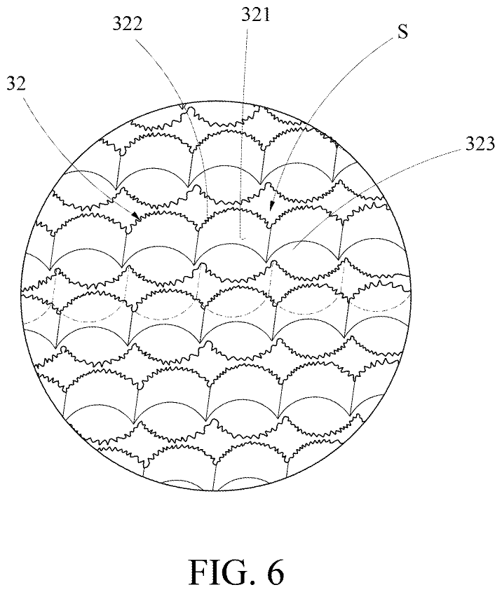

Referring to FIG. 6, each pore 32 has a peripheral wall 321. The peripheral wall 321 is a wall extending from the surface portion S toward the interior of the implant 31, and the pore 32 is enclosed by the peripheral wall 321. The peripheral wall 321 and the surface portion S meet at an end edge 322. Adjacent end edges 322 of the adjacent pores 32 are joined to allow the adjacent peripheral walls 321 to connect with each other. Therefore, one pore 32 is open to the next pore 32, and adjacent pores 32 communicate one after another to define a channel 323. By rows of the communicating pores 32, the implant 32 forms plurality of channels 323. Various communicating arrangements of the channels 323 are shown in FIGS. 5A-5C and will be described in detail. For the sake of concision, FIG. 6 only illustrates a perspective view of the arrangement shown in FIG. 5A, and FIGS. 4A-4H only show that the pores 32 are formed in the communicating state shown in FIG. 5A. Preferably, the end edge 322 of each pore 32 is provided with a non-smooth border. For example, the place where the peripheral wall 321 touches the surface portion S forms a notched or tooth-like line, which causes the end edge 322 to become uneven. The uneven end edge 322 is taken as an example for the operation.

The joining direction of the pores 32 decides the communicating arrangement of each channel 323. For example, the pores 32 are joined around the surface portion S in a lateral direction X (as shown), so the channels 323 each are independently formed in a lateral communication to provide a lateral communicating space, shown in FIG. 5A and FIG. 6. Alternatively, the pores 32 are joined in a longitudinal or axial direction Y (as shown), so the channels 32 each are independently formed in a longitudinal communication to provide a longitudinal communicating space (shown in FIG. 5B). Alternatively, the pores 32 are joined in both directions X and Y to interlink adjacent channels 323 whereby a mutual communication is formed between the channels to provide both of longitudinal and lateral communicating spaces (shown in FIG. 5C). The above communicating types allow cells to be evenly and regularly distributed during the process of adhesion and proliferation and assist the cells in linking together to wrap and fix the entire implant 31 firmly. The arrangement of FIG. 5A is taken as an example for the operation.

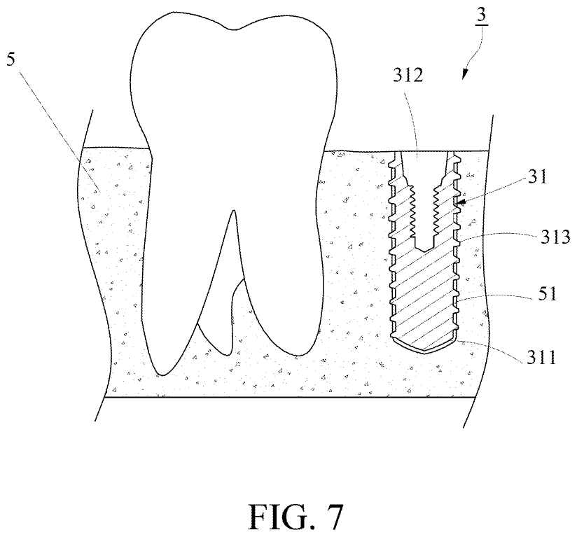

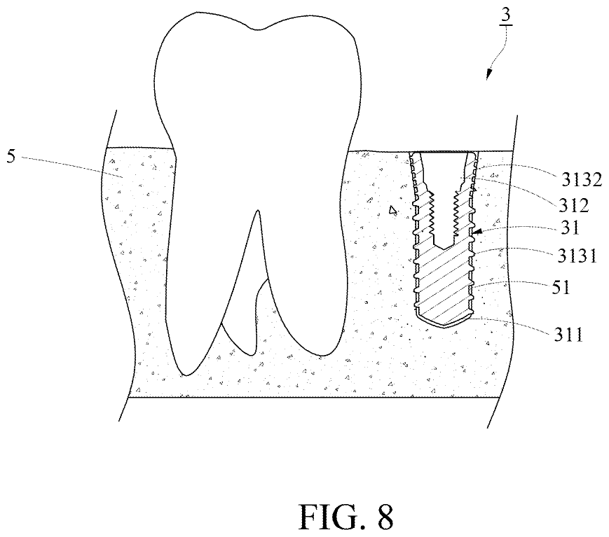

The operation of this invention is described with the aid of FIG. 7. The implant device 3 is used as a fixture implanted into an alveolar bone 5 in the oral cavity. To start an implanting operation, a surgical tool (not shown) is inserted into the positioning hole 312 and rotates to cause the threaded portion 313 to cut an inner wall of a predrilled hole 51 of the alveolar bone 5 and fasten in position. As shown in FIG. 8, if the implant 31 provides two thread sections 3131, 3132, the first thread section 3131 with a larger pitch P1 has a large contact area to cut the inner wall and screw into the hole 51. The second thread section 3132 with a smaller pitch P2 follows the screwing tracks of the first thread section 3131 to continue the cutting and screwing action. This design attains a quick fastening action, helps relieve discomfort of patients during the implanting operation, and attains a stable positioning effect.

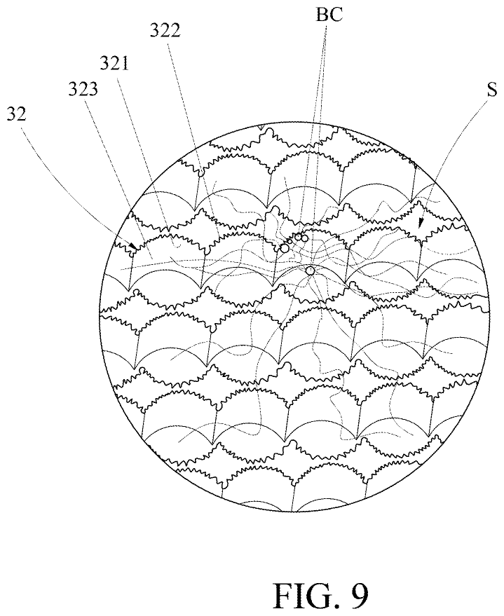

After the implant 31 is implanted into the alveolar bone 5, bone cells BC, as briefly shown in FIG. 9, are derived from the bone 5 during the process of convalescing. The end edges 322 of the pores 32 has an uneven or non-smooth border, so the cells BC grip the end edges 322 quickly and smoothly to enter the pores 32 and then execute the adhesion and proliferation inside and outside the pores 32. Specifically, after the cells BC go into the pores 32 along the end edges 322 and become attached, the cells BC are quickly adhered to the peripheral walls 322 in the channels 323 and execute the cell proliferation as a result of cell growth and cell division. Because an inner communicating space is formed through each channel 323, the proliferated cells or accretions BC climb and stretch along the peripheral walls 322 continuously and distribute over each channel 323. Then, the cells BC project from the respective channels 323 and pores 32 and grow along the surface portion S like a creeping or climbing plant to attach other channels 323 and pores 32 for adhesion. Finally, the cells BC link with each other and wrap the entire implant 31 to fix the implant 31 to the alveolar bone 5 firmly and prevent it from loosening. This increases the osseointegration between the implant 31 and the alveolar bone 5.

Therefore, the communicating pores 32 or the cooperation between the communicating pores 32 and the uneven end edges 322 allow the bone cells BC to be smoothly and quickly attached to the end edges 322 and the pores 32 to increase the initial adhesion and growth of cells BC. The cells BC are continuously adhered to the channels 323 for growing, stretching and distributing quickly and evenly. The inner communicating space of each channel 323 provides a wide contact area for the adherence and growth of osteocytes. Namely, the contact surface area between the implant 31 and the cells BC is increased, so the cell adhesion and growth ability can be efficiently increased to assist cells BC in executing the rapid and smooth adhesion, proliferation and close linking action. Thus, the osseointegration effect is enhanced to speed up the process of healing the osseous tissue of the alveolar bone, which helps shorten the convalescence period.

To sum up, this invention mainly includes pores recessedly formed into the surface portion of the implant and channels formed by joining adjacent end edges of adjacent pores. Accordingly, cells obtained from the target part where the implant is fastened are attached to the pores smoothly and go into each channel for quick adhesion, distribution and proliferation. Proliferated cells or accretions further link with each other between pores and channels. Therefore, it takes the cells less time to be adhered to the implant, and the entire implant is wrapped by the cells and held in position firmly to increase the combination effect between the implant and the target part, prevent the implant from loosening, and heal the target part quickly.

While the embodiments of this invention are shown and described, it is understood that further variations and modifications may be made without departing from the scope of this invention.

What is claimed is:

1. An implant device comprising an implant having a first end and a second end opposite to said first end, wherein said implant includes a drilling portion disposed at said first end, a positioning hole formed at said second end, and a threaded portion spirally disposed between said first end and said second end;
wherein a plurality of pores are recessedly formed into a surface portion of said implant, said surface portion including a shank surface exposed when adjacent threads of said threaded portion are axially spaced apart, each of said plurality of pores having a peripheral wall, said peripheral wall and said surface portion meeting at an end edge, adjacent end edges and peripheral walls of said plurality of adjacent pores being joined to each other to allow said adjacent pores to communicate one after another in a row and thus define a channel, rows of said communicating pores defining a plurality of channels.

2. The implant device according to claim 1, wherein each end edge of each of said pores is provided with a non-smooth border.

3. The implant device according to claim 1, wherein said surface portion further includes a thread surface of said threads of said threaded portion.

4. The implant device according to claim 1, wherein said threaded portion includes at least two thread sections, respective thread pitches being formed between any two adjacent threads of respective thread sections, said thread pitches being different from each other.

5. The implant device according to claim 2, wherein said threaded portion includes at least two thread sections, respective thread pitches being formed between any two adjacent threads of respective thread sections, said thread pitches being different from each other.

6. The implant device according to claim 3, wherein said threaded portion includes at least two thread sections, respective thread pitches being formed between any two adjacent threads of respective thread sections, said thread pitches being different from each other.

7. The implant device according to claim 4, wherein said second end has a second maximum outer diameter larger than a first maximum outer diameter of said first end.

8. The implant device according to claim 5, wherein said second end has a second maximum outer diameter larger than a first maximum outer diameter of said first end.

9. The implant device according to claim 6, wherein said second end has a second maximum outer diameter larger than a first maximum outer diameter of said first end.

10. The implant device according to claim 1, wherein said end edges of said pores are joined in a lateral direction to allow each channel to be independently formed in a lateral communication.

11. The implant device according to claim 2, wherein said end edges of said pores are joined in a lateral direction to allow each channel to be independently formed in a lateral communication.

12. The implant device according to claim 1, wherein said end edges of said pores are joined in a longitudinal direction to allow each channel to be independently formed in a longitudinal communication.

13. The implant device according to claim 2, wherein said end edges of said pores are joined in a longitudinal direction to allow each channel to be independently formed in a longitudinal communication.

14. The implant device according to claim 1, wherein said end edges of said pores are laterally and longitudinally joined to interlink adjacent channels whereby a mutual communication is formed.

15. The implant device according to claim 2, wherein said end edges of said pores are laterally and longitudinally joined to interlink adjacent channels whereby a mutual communication is formed.
